(19) United States
(12) Patent Application Publication
(10) Pub. No.: US 2014/0271974 A1
(43) Pub. Date: Sep. 18, 2014

(54) CONFORMING COOLING METHOD AND MOLD

(71) Applicant: HONDA MOTOR CO., LTD., Tokyo (JP)

(72) Inventor: Alan J. Hughes, Prospect, OH (US)

(21) Appl. No.: 13/830,163

(22) Filed: Mar. 14, 2013

(51) Int. Cl. B29C 33/02; B23K 31/02

(52) U.S. Cl. CPC B29C 33/02; B23K 31/02
USPC 425/404; 228/101; 228/174

(57) ABSTRACT

A conformal cooling method and mold includes a part producing mold having a fluid passage defined therein that includes a channel defined in a surface of the mold, a weld support received in the channel, and a bridge welded across the channel above the weld support for closing the channel and defining the fluid passage. To form the fluid passage, the weld support is installed in the channel defined in the mold surface and the bridge is welded across the channel above the weld support for closing the channel.

### BACKGROUND

It is known to provide conformal cooling passages within a mold for purposes of cooling the mold and/or a part produced by the mold. In particular, conformal cooling passages can be used to provide more uniform cooling of the part produced by the mold. Cooling passages are conformal when they generally conform to or follow the contour of the part produced by the mold and are disposed beneath the finished mold surface. When the part to be produced by the mold has a relatively complex shape, provisioning the mold with the conformal cooling passages can be difficult.

### SUMMARY

According to one aspect, a method for forming a fluid passage in a mold includes installing a weld support in a channel defined in a surface of the mold and welding a bridge across the channel above the weld support for closing the channel.

According to another aspect, a method of forming a fluid passage in a mold includes providing a mold surface with a channel having a closed bottom and an opening, installing a weld support between a first wall and a second wall of the channel, the weld support positioned below the opening, and welding a bridge above the weld support between the first wall and the second wall of the channel. The bridge is positioned below the opening to define the fluid passage.

According to a further aspect, a part producing mold having a fluid passage defined therein includes a channel defined in a surface of the mold, a weld support received in the channel, and a bridge welded across the channel above the weld support for closing the channel and defining the fluid passage.

### BRIEF DESCRIPTION OF THE DRAWINGS

FIG. 1 is a top elevational view of a part producing mold having a fluid passage defined therein.

FIG. 2 is a cross-sectional view taken along the line 2-2 of FIG. 1 showing the fluid passage.

FIGS. 3A-3E are cross-sectional views illustrating a method for forming the fluid passage in the mold according to one exemplary embodiment.

FIGS. 4A-4D are cross-sectional views illustrating a method for forming the fluid passage in the mold according to an alternate exemplary embodiment.

FIGS. 5A-5D are cross-sectional views illustrating a method for forming the fluid passage in the mold according to another alternate exemplary embodiment.

FIGS. 6A-6D are cross-sectional views illustrating a method for forming the fluid passage in the mold according to yet another alternate exemplary embodiment.

### DETAILED DESCRIPTION

With reference now to the drawings wherein the showings are for purposes of illustrating one or more exemplary embodiments and not for purposes of limiting same, FIG. 1 shows a part producing mold 10 having a fluid passage 12 defined therein. As is known and understood by those skilled in the art, the fluid passage 12 can be a cooling fluid passage through which a coolant is directed for cooling the part producing mold 10 and/or a part (not shown) molded by the part producing mold 10. In the illustrated embodiment, the fluid passage 12 follows a circuitous path through the part producing mold 10 from a coolant inlet 14 to a coolant outlet 16. As is to be appreciated and understood by those skilled in the art, the particular path followed by the fluid passage 12 need not be limited to that shown. In particular, the path, size and spacing of the fluid passage 12 can vary as necessary to provide the desired cooling effect. Further, while only one fluid passage 12 is shown and described herein, it will be appreciated and understood that more than a single fluid passage could be provided.

As shown in the illustrated embodiment, and with additional reference to FIG. 2, the fluid passage 12 is disposed below a mold surface 18 of the mold 10 and can generally follow a contour of the mold surface 18. The mold surface 18, in which the channel 30 is defined, can be contoured, as shown in the illustrated embodiment. In the illustrated embodiment, the mold 10 is shown as a single mold half but it is to be appreciated that another mold half can be provided (though not shown herein) to close a mold cavity 20 as is known and understood by those skilled in the art.

With further reference to FIGS. 3A-3E, and as will be described in more detail below, the mold 10 having the fluid passage 12 defined therein can include a channel 30 defined in the mold surface 18 of the mold 10, a weld support 32 received in the channel 30 and a bridge 34 welded across the channel 30 above the weld support 32 for closing the channel 30 and defining the fluid passage 12. Additionally, the mold 10 can include a class A machined surface 36 including and extending across the mold surface 18 of the mold 10 and the bridge 34.

A method for forming the fluid passage 12 in the mold 10 will now be described according to an exemplary embodiment. In the method, the weld support 32 is installed in the channel 30 defined in the mold surface 18 of the mold 10 as shown in FIG. 3A. After the weld support 32 is installed, the bridge 34 is welded across the channel 30 above the weld support 32 for closing the channel 30 as shown in FIG. 3C. In the embodiment of FIGS. 3A-3E, the weld support 32 is a nonconsumable weld support, though this is not required. Additionally, the weld support 32 of this embodiment can be a strip of rigid material (e.g., steel) that is installed in the channel. The weld support 32 can have one of a generally planar configuration or a curved configuration, and is shown having a generally planar configuration in the embodiment depicted in FIGS. 3A-3E.

Installing the weld support 32 in the channel 30 can include welding the weld support 32 within the channel 30 at a location spaced apart from a lower end 30a of the channel 30 and from the mold surface 18. This welding of the weld support 32 within the channel 30 can include welding a first end edge 32a of the weld support 32 to a first lateral wall 40 defining the channel 30 and a second end edge 32b of the weld support 32 to a second lateral wall 42 defining the channel 30. This step of welding the weld support 32 within the channel 30 (i.e., welding the first and second edge edges 32a, 32b to the first and second lateral walls 40, 42) precedes and is separate from the step of welding the bridge 34 across the channel 30 above the weld support 32 in the embodiment illustrated in FIGS. 3A-3E. Thus, the weld support 32 is a separate and disparate element from the bridge 34 in the depicted embodiment. Welding of the weld support 32 within the channel 30 can be done using a conventional TIG welder such as the illustrated welder 44, though other types of welders could be used if desired. Alternatively, no specific welding of the weld support 32 need be done and welding of the bridge 34 could commence after placement of the weld support 32 without a separate step of welding the weld support 32 in position.

The channel 30 is defined by the spaced apart lateral walls 40, 42 that depend from the mold surface 18 of the mold 10. The spaced apart lateral walls 40, 42 can be at least one of parallel with one another (e.g., as depicted in the embodiments of FIGS. 5A-5D and FIGS. 6A-6D) or angled so that lower ends thereof converge toward one another (e.g., as shown in the embodiment depicted in FIGS. 3A-3E and 4A-4D) or curved (embodiment not shown). In the embodiment of FIGS. 3A-3E, the spaced apart lateral walls 40, 42 are angled and lower ends 40a, 42a of the spaced apart lateral walls 40, 42 converge toward one another but are spaced apart from the lower end 30a of the channel 30. Additionally in the illustrated embodiment, spaced apart shoulders 46, 48 are defined adjacent to lower ends 40a, 42a of the spaced apart lateral walls 40, 42 and the shoulders 46, 48 are spaced apart from the lower end of the channel 30a. The lower end 30a can depend from the shoulders 46, 48 and have a generally curved configuration that is U-shaped in the embodiment illustrated in FIGS. 3A-3E. As shown, the weld support 32 can rest on the shoulders 46, 48. That is, the shoulders 46, 48 can extend inwardly toward one another relative to the lateral walls 40, 42 and can define a dimension that is shorter than a dimension of the weld support 32 spanning the channel 30. In particular, in the illustrated embodiment, the spaced apart shoulders 46, 48 are defined along the lateral walls 40, 42 defining the channel 30. The spaced apart shoulders 46, 48 are spaced apart from the lower end 30a of the channel 30 and spaced apart from the mold surface 18 of the mold in a direction parallel with a depth of the channel (e.g., the depth dimension extending along the axis 50 shown in FIG. 3A). Also as shown, the spaced apart lateral walls 40, 42 can be angled at approximately 20 degrees relative to a depth of the channel 30 (i.e., the depth defined along the axis 50) in the illustrated embodiment, though this is not required.

The step of welding the bridge 34 across the channel 30 above the weld support 32 for closing the channel 30 is shown in progress in FIG. 3C. Particularly, welding the bridge 34 across the channel 30 can include filling a cavity 52 defined between the weld support 32 and the mold surface 18 of the mold with a fill material 54. In the illustrated embodiment, the fill material 54 is weld deposit material from the welder 44 that is incrementally deposited to form the bridge 34 via filling the cavity 52. Filling the cavity 52 can include filling an entirety of the cavity and can further include filling the cavity 52 with the fill material 54 beyond the mold surface 18 of the mold as shown in FIG. 3D. That is, the fill material 34 can be deposited within the cavity 30 above the weld support 32 so that the fill material 54 completely fills the cavity 52 and overflows from the cavity 52 so as to extend upward beyond the mold surface 18 of the mold 10. Such filling can ensure complete filling of the cavity 52 without any voids. It is to be appreciated by those skilled in the art that the step of welding the bridge 34 can be at least one of robotically welded or manually welded.

Thereafter, the fill material 54 can be reduced, particularly the fill material 54 filled beyond the surface of the mold 18 can be reduced, so that an upper surface 54a of the fill material 54 is contiguous with the mold surface 18. In one embodiment, such reduction of the fill material 54 is obtained by machining the fill material 54 until a class A machined surface 36 extends from the mold surface 18 of the mold 10 across the bridge 54 as shown in FIG. 3E. The result, as shown in FIG. 3E, is a closed fluid passage 12 defined by the weld support 32, and the bridge 34 both disposed above the fluid passage 12 and integrated as part of the mold 10 via the welding processes discussed hereinabove.

Optionally, the method described in FIGS. 3A-3E can include cutting the channel 30 into the mold surface 18 of the mold 10 before installing the weld support 32 and welding the bridge 34, though this is not required. In particular, the mold 10 can be provided with the channel 30 already defined therein so that the method need not require the step of cutting the channel 30 into the mold surface 18 of the mold 10. In one embodiment, though again not required, the method can include forming the mold 10 and the mold surface 18 of the mold 10 with the channel 30 by at least one of casting the mold 10, molding the mold 10 or welding the mold 20, techniques that are known and understood by those skilled in the art.

With reference now to FIGS. 4A-4D, a method for forming the fluid passage 12 in the mold 10 will be described according to an alternate exemplary embodiment. The method of FIGS. 4A-4D can be the same or similar to the method of FIGS. 3A-3E except as indicated hereinbelow and thus like reference numbers will be used to identify like elements and like reference numbers with the addition of a prime symbol (′) will be used to identify corresponding elements that vary between the embodiments. Like the method of FIGS. 3A-3E, the method of FIGS. 4A-4D can include installing a weld support 32′ in the channel 30 defined in the mold surface 18 of the mold 10 and can include welding a bridge 34′ across the channel 30 above the weld support 32′ for closing the channel 30. Details of the channel 30 in FIGS. 4A-4D can be as described in connection with the channel 30 of FIGS. 3A-3E.

Unlike the weld support 32, the weld support 32′ has a generally curved configuration. In particular, the weld support 32′ can have a tubular configuration for defining the fluid passage 12 with a generally circular cross-section. As shown, the curvature of the tubular weld support 32′ can match the curvature of the lower end 30a of the channel 30 so that the weld support 32′ can be complementarily received within the channel 30 against the lower end of 30a in tight fitting arrangement as depicted in FIG. 4B. Accordingly, installing the weld support 32′ in the channel 30 defined in the mold surface 18 of the mold 10 involves positioning the weld support 32′ against the lower end 30a of the channel 30 as shown in FIGS. 4A and 4B. Due to the complementary fit, no welding of the weld support 32′ need be done as discussed above in connection with the weld support 32. Instead, once the weld support 32′ is in position, the bridge 34′ can be welded across the channel 30 above the weld support 32′ for closing the channel 30. Such welding of the bridge 34′ can be as described hereinabove in connection with the bridge 34 of FIGS. 3A-3E. That is, welder 44 can be used to deposit a fill material 54 (e.g., weld material) within cavity 52′ defined between the weld support 32′ and the mold surface 18 of the mold 10.

Like the method of FIGS. 3A-3E, welding the bridge 34′ can include fully filling the cavity 52′ with the fill material 54 and can further include filling the cavity 52′ with the fill material 54 beyond the mold surface 18 of the mold as shown in FIG. 4C. Thereafter, the fill material 54 filled beyond the mold surface 18 of the mold 10 can be reduced so that the upper surface 54a of the fill material 54 is contiguous with the mold surface 18 of the mold 10 as shown in FIG. 4D. As discussed above, this can include machining the fill material 54 to create a class A machined surface 36′.

In one embodiment, the weld support 32′ is a consumable weld support. In particular, the weld support 32′ can be consumed after the bridge 54 is welded across the channel 30 above the weld support 32′ so that the weld support 32′ no longer occupies any space within the mold 10. In one embodiment, the weld support 32′ is a consumable weld support that is dissolved after welding the bridge 54 across the channel 30. Such dissolving of the weld support 32′ can include flushing a dissolving material (e.g., water) through the fluid passage 12 to dissolve and remove the weld support 32′ from the mold 10. In one embodiment, the consumable weld support 32′ is formed from a semi-solid paste derived from a borax or sulfur based slurry, though other compositions could be used.

With reference now to FIGS. 5A-5D, another method for forming the fluid passage in a mold will be described. The method depicted in FIGS. 5A-5D can be the same as either of the methods of FIGS. 3A-3E or FIGS. 4A-4D except as indicated below. Like elements are shown in FIGS. 5A-5D with like reference numbers and corresponding elements are shown with like reference numbers with the addition of a prime symbol. In general, the method of FIGS. 5A-5D is the same as the previously described methods in that a weld support 32″ is installed in a channel 30′ defined in a surface 18′ of a mold 10′ and bridge 34″ is welded across the channel 30′ above the weld support 32″ for closing the channel 30′.

As shown, the weld support 32″ is a strip of rigid material (e.g., steel) and has a curved configuration. Unlike the weld support 32′, however, the weld support 32″ is not a tubular element but is a half-curved element. Also as shown, spaced apart lateral walls 40′, 42′ are generally parallel to one another (i.e., are not angled relative to one another). In the method of FIGS. 5A-5D, the weld support 32″ is installed in the channel 30 at a location spaced apart from a lower end 30a′ of the channel 30′ and from the mold surface 18′. The welder 44 can deposit fill material 54 (e.g., weld material) above the weld support 32″ to fill a cavity 52″ defined between the weld support 32″ and the mold surface 18′ of the mold 10′ (see FIG. 5B). As with the earlier described methods, the fill material 54 can completely fill the cavity 52″ and extend beyond the mold surface 18′ of the mold 10′ as shown in FIG. 5C. Thereafter, the fill material 54 can be reduced so that an upper surface 54a of the fill material 54 is contiguous with the mold surface 18′ of the mold 10′ as shown in FIG. 5D.

FIGS. 6A-6D illustrate yet another method for forming a fluid passage in a mold. The method of FIGS. 6A-6D can be the same as the method of FIGS. 5A-5D with the exception that the weld support 32″ is replaced by the weld support 32′ described in connection with the method of FIGS. 4A-4D. As shown in FIG. 6A, the weld support 32′ can be installed within the channel 30′ in a complementary relation. That is, the weld support 32′ can complementarily fit against the lower end 30a′ of the channel 30′ as shown in FIG. 6B. Then, with continued reference to FIG. 6B, the welder 44 can begin depositing fill material (e.g., weld material) 54 in the cavity 52″ disposed between the weld support 32′ and the mold surface 18′ of the mold 10′. The fill material 54 can continue to be deposited until the cavity 52″ is completely filled and can be filled so as to extend beyond the mold surface 18′ of the mold 10′ as shown in FIG. 6C. Thereafter, the fill material 54 extending beyond the mold surface 18′ can be reduced so that upper surface 54a of the fill material 54 is contiguous with the mold surface 18′ of the mold 10′. Optionally, the weld support 32′ can be a consumable weld support as described hereinabove and therefore can be dissolved as shown in FIG. 6D so as to no longer occupy space within the mold 10′

According to the methods described herein, a method of forming a fluid passage in a mold is described that includes providing a mold surface with a channel having a closed bottom and an opening. The method further includes installing a weld support between a first wall and a second wall of the channel, wherein the weld support is positioned below the opening. Additionally, the method includes welding a bridge above the weld support between the first wall and the second wall of the channel, wherein the bridge is positioned below the opening to define the fluid passage. Providing the mold surface with a channel can optionally include at least one of cutting the channel into the mold surface, casting the mold with a channel defined in the mold surface, molding the mold with a channel defined in the mold surface, or welding the mold with the channel defined in the mold surface, though this is not required and the method can presume that a mold is already provisioned with the channel defined therein.

As will be appreciated and understood by those skilled in the art, the methods described herein can provide a part producing mold (e.g., mold 10, 10′) having a fluid passage 12 defined therein that includes the channel 30 or 30′ defined in the mold surface 18 or 18′ of the mold 10 or 10′, weld support 32, 32′ or 32″ received in the channel 30 or 30′ and the bridge 34, 34′ welded across the channel 30 or 30′ above the weld support for closing the channel and defining the fluid passage 12. The weld support can have one of a tubular configuration (weld support 32′), a planar strip configuration (weld support 32), or a curved strip configuration (weld support 32″). Also, the channel can be defined by spaced apart lateral walls depending from the surface of the mold and the spaced lateral walls can be at least one of parallel to one another (as shown in the methods of FIGS. 5A-5D and 6A-6D) or angled so that lower ends thereof converge towards one another (as shown in the methods of FIGS. 3A-3E and FIGS. 4A-4D) or can be curved (not shown herein).

It should also be appreciated and understood that any of the features associated with the methods discussed herein can be mixed and matched with other of the methods described herein. For example, the weld support 32″ could be used in association with the shoulders 46, 48 depicted in FIGS. 3A-3E and/or the angled lateral walls 40, 42 depicted in FIGS. 3A-3E. It will also be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for forming a fluid passage in a mold, comprising:
installing a weld support in a channel defined in a mold surface of the mold; and
welding a bridge across the channel above the weld support for closing the channel.

2. The method of claim 1 wherein welding the bridge across the channel includes filling a cavity defined between the bridge and the mold surface with a fill material.

3. The method of claim 2 wherein filling the cavity includes filling the cavity with the fill material beyond the mold surface.

4. The method of claim 3 further including:
reducing the fill material filled beyond the mold surface so that an upper surface of the fill material is contiguous with the mold surface.

5. The method of claim 2 wherein the fill material is weld material.

6. The method of claim 1 wherein the weld support is a consumable weld support.

7. The method of claim 2 further including:
dissolving the consumable weld support after welding the bridge across the channel.

8. The method of claim 6 wherein the consumable weld support has a tubular configuration for defining the fluid passage with a generally circular cross-section.

9. The method of claim 1 wherein the weld support is a nonconsumable weld support.

10. The method of claim 9 wherein installing the weld support in the channel includes welding the weld support within the channel at a location spaced apart from a lower end of the channel and from the mold surface.

11. The method of claim 10 wherein welding the weld support within the channel includes welding a first end edge of the weld support to a first lateral wall defining the channel and a second end edge of the weld support to a second lateral wall defining the channel.

12. The method of claim 9 wherein the nonconsumable weld support is a strip of rigid material.

13. The method of claim 12 wherein the nonconsumable weld support has one of a generally planar configuration or a curved configuration.

14. The method of claim 1 wherein the channel is defined by spaced apart lateral walls depending from the mold surface, and wherein the spaced apart lateral walls are at least one of parallel with one another, angled so that lower ends thereof converge toward one another or curved.

15. The method of claim 14 wherein the spaced apart lateral walls are angled and the lower ends of the spaced apart lateral walls are spaced apart from a lower end of the channel.

16. The method of claim 15 wherein spaced apart shoulders are defined adjacent the lower ends of the spaced apart lateral walls and the shoulders are spaced apart from the lower end of the channel.

17. The method of claim 15 wherein each one of the spaced apart lateral walls is angled at approximately twenty degrees relative to a depth of the channel.

18. The method of claim 1 wherein spaced apart shoulders are defined along the walls defining the channel, the spaced apart shoulders spaced apart from a lower end of the channel and spaced apart from the mold surface in a direction parallel with a depth of the channel.

19. The method of claim 1 wherein the mold surface in which the channel is defined is contoured.

20. The method of claim 1 further including:
cutting the channel into the mold surface.

21. The method of claim 1 further including:
forming the mold and the mold surface with the channel by at least one of casting the mold, molding the mold or welding the mold.

22. The method of claim 1 wherein welding the bridge is at least one of robotically welded or manually welded.

23. A method of forming a fluid passage in a mold, comprising:
providing a mold surface with a channel having a closed bottom and an opening;
installing a weld support between a first wall and a second wall of the channel, the weld support positioned below the opening; and
welding a bridge above the weld support between the first wall and the second wall of said channel, the bridge positioned below the opening to define the fluid passage.

24. The method of claim 23 wherein providing the mold surface with the channel includes at least one of cutting the channel into the mold surface, casting the mold with the channel defined in the mold surface, molding the mold with the channel defined in the mold surface or welding the mold with the channel defined in the mold surface.

25. A part producing mold having a fluid passage defined therein, comprising:
a channel defined in a mold surface of the mold;
a weld support received in the channel; and
a bridge welded across the channel above the weld support for closing the channel and defining the fluid passage.

26. The part producing mold of claim 25 further including:
a class A machined surface extending from the mold surface of the mold across the bridge.

27. The part producing mold of claim 25 wherein the weld support has one of a tubular configuration, a planar strip configuration or a curved strip configuration.

28. The part producing mold of claim 25 wherein the channel is defined by spaced apart lateral walls depending from the mold surface of the mold, and wherein the spaced apart lateral walls are at least one of parallel with one another or angled so that lower ends thereof converge toward one another or curved.

29. The part producing mold of claim 28 wherein the spaced apart lateral walls are angled and the lower ends of the spaced apart lateral walls are spaced apart from a lower end of the channel.

30. The part producing mold of claim 29 wherein spaced apart shoulders are defined adjacent the lower ends of the spaced apart lateral walls and the shoulders are spaced apart from the lower end of the channel.

31. The part producing mold of claim 29 wherein each one of the spaced apart lateral walls is angled at approximately twenty degrees relative to a depth of the channel.
